(19) United States
(12) Patent Application Publication
(10) Pub. No.: US 2013/0073982 A1
(43) Pub. Date: Mar. 21, 2013

(54) Method and system for indicating categories in electronic messages

(71) Applicant: Rania Abouyounes, Windsor (CA)

(72) Inventor: Rania Abouyounes, Windsor (CA)

(21) Appl. No.: 13/233,135

(22) Filed: Sep. 15, 2011

(51) Int. Cl. G06F 3/01; G06F 15/16

(52) U.S. Cl. 715/752

(57) ABSTRACT

Method and system for adding a category icon to an electronic message, created by a sender to one or more recipients of a user community, are disclosed. The computer implemented method includes: providing the sender with a list of user community types when creating the electronic message; receiving from the sender the selection of a user community type from the list of user community types; providing the sender with a list of categories for the selected user community type and a category icon associated with each category; receiving from the sender the selection of a category from the list of categories; and appending the category icon corresponding to the selected category to the electronic message, wherein the category icon is subsequently displayed with the electronic message to one or more recipients of a user community to provide visual identification of the category of each electronic message.

### FIELD OF THE INVENTION

The present invention relates to systems and methods for managing electronic communications. More particularly, the present disclosure relates to systems and methods for electronically distributing messages in specific message format to one or more user communities. The present disclosure also relates to electronically providing an interface for managing and distributing messages to recipients.

### BACKGROUND OF THE INVENTION

There are many methods and systems that facilitate communications between people using electronic messages in the form of emails, instant messages or short posted messages. Commercial and social sites and systems such as Hotmail, Gmail, Twitter, and Facebook provide email and instant message capabilities to their users. A user can utilize a web browser on a personal computer or mobile device as a display medium to login to a central email server such as Hotmail or Gmail. Users can also use their mobile phones to login to their emails. Short messages in the form of instant messages, SMS or Twitter tweets are limited in length but users can view tens of short messages in one screen.

Electronic email messages can be composed of multiple parts such as the title or subject, body, sender, the receivers and any type of one or more file attachments. Short or instant messages are composed of one main body where the sender is identified by an icon or a short name.

There are many methods and systems that can append icon indicators to electronic text messages. Some methods append icons to indicate the status of the sender (e.g. working, sleeping, away), some icons indicate the type of instant message community (e.g. AOL, msn, twitter), some icons indicate the type of message (e.g. text, voice), some icons indicate impressions or emotions (e.g. happy, sad, surprised), some icons represent prepared sentences to help speed up the typing of messages, and some icons represent the sender (e.g. professional logo, personal picture) so the recipients of messages can easily recognize their senders.

A search of prior art did not disclose any patents that read directly on the claims of this invention. Some existing U.S. patents were considered to be related to the subject of using icons in messages. For example, in U.S. Patent Application No. 20100205545, a method and system was proposed for appending indicative icons representing the sender. In U.S. Pat. No. 7,406,308, an indicative icon was added to the short message to correspond to the type of message being text, image or voice. In U.S. Pat. No. 7,962,559, icons representing instant messaging communities are used to help users select and view messages to and from different instant messaging communities. In U.S. Pat. No. 6,990,452 and US Patent Application No. 20060282503, emoticons and emotiflags are added to text messages and emails respectively. In US Patent Application No. 20110078564, the full meaning of text message is converted to graphical format. In US Patent Application No. 20100005065, users can select from many icons to generate vocabulary in a text message. In US Patent Application No. 20080216022, users can build the entire message from icons that belong to standard categories and at least one personal category shared by a group of users such as emotions, actions or things where icons are used to build the entire message. However, the category icon itself is not part of the message. In US Patent Application No. 20080119211, an animated icon is added to alert the user of newly received messages.

### SUMMARY OF THE INVENTION

This invention is about the addition of a category or area of interest indicator in the form of an icon to electronic messages to visually identify the category of a message from a list of messages. An icon is appended to the front or back of each displayed text message indicating the category, topic or area of interest that the message addresses or belongs to. The sender selects and inserts the category, topic or area of interest icon by browsing through a list of user community types and a list of categories for each user community type. The indicative icon corresponding to the category can help electronic message recipients identify what they are looking for quickly without having to read each message title or subject and without having to click through multiple categories or topics to read through messages posted for each category. By displaying all messages along with their appended category icons representing different categories or topics at the same display area of a computer screen or mobile device screen, message recipients and viewers can quickly identify the categories or topics they are interested in while viewing other categories or topics they are not interested in but may become interested in when seeing that many messages were posted for such categories. Viewing multiple categories or topics is a time saver where viewers do not need to access each category or topic to see what messages are posted under each category.

### BRIEF DESCRIPTION OF THE DRAWINGS

FIGS. 1 and 2 show flow diagrams depicting implementations of methods according to aspects of the invention;

FIG. 3 is a schematic diagram illustrating a system that incorporates a method in accordance with the present invention; and

FIG. 4 is a web interface illustrating how icons are associated with categories for an example user community type and how category icons are displayed with posted short messages.

### DETAILED DESCRIPTION OF THE ILLUSTRATED EMBODIMENTS

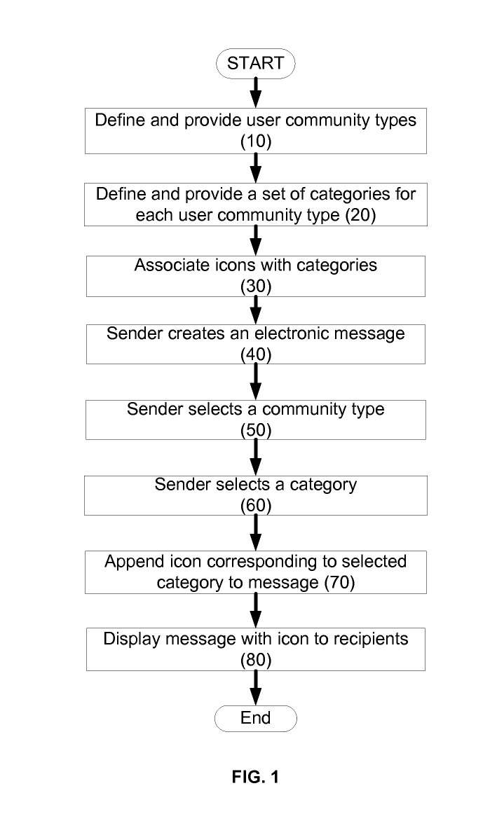

A simple process flow that depicts this proposed method is shown in FIG. 1 where user community types are defined and provided to message senders (10), categories for each user community type are defined and provided to message senders (20) and icons are associated with each category (30). When a sender creates an electronic message (40) as an email or a short post, the user selects the user community where the electronic message is going to be sent (50) and selects the category for that user community (60) where the icon corresponding to the selected category is appended to the electronic message (70). The list of messages for a user community is displayed while appending the icon corresponding to the category to each displayed electronic message (80).

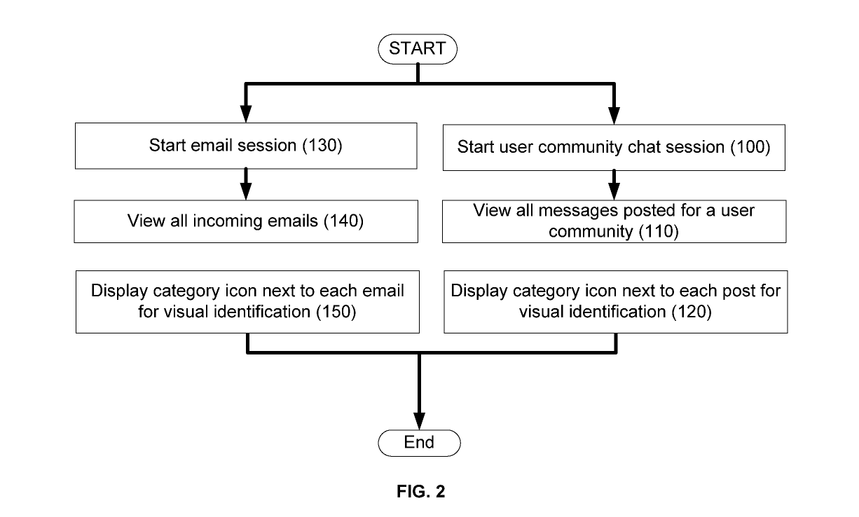

FIG. 2 shows the major steps involved in viewing a list of electronic messages. Message recipients start a user community chat session (100) by logging into a chat program or a chat web site or can also start an email session (130) by logging into an email program or email web site. Recipients can view all posted messages to a user community (110) or all their incoming emails (140). The category or area of interest icon is displayed next to each posted user community message (120) or next to for each email message (150) for visual identification of the category or area of interest of the message.

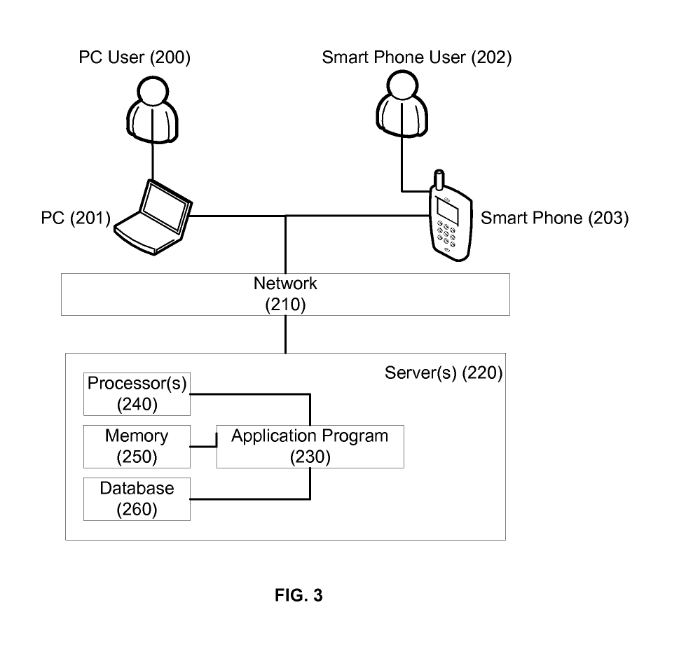

FIG. 3 shows one implementation of the system for adding category icons in electronic messages for user communities having multiple categories comprising: application program (230) running on one or more processors (240) and memory (250) attached to a network accessible database (260) where user community types, their categories and icons associated with each category are stored. The application program (230) is deployed on servers (220) and those servers are connected to the network (210) to interact with message senders and receivers. A personal computer user (200) is using a personal computer client (201) and a Smart Phone user (202) is using a Smart Phone client (203) to connect to the application program (230) through the network (210) to send and receive emails or short messages.

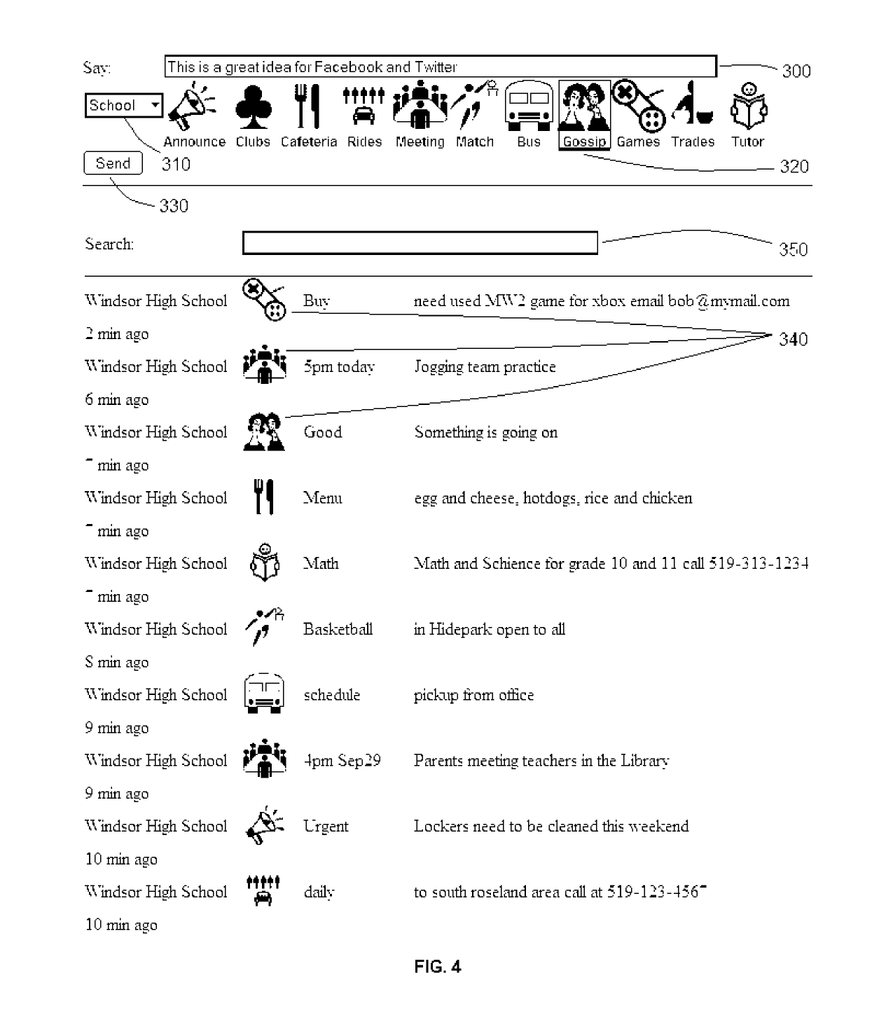

FIG. 4 shows an example user interface of a web page where electronic messages are posted to a user community and messages are listed along with the category icons for the school user community type. The message sender can select the target user community name when starting the messaging session or by entering the user community name as part of the text message. The user community type can also be pre-selected for the sender based on the user community name or there can be a default user community type with default categories. The message sender types the text message (300) in a text box, selects the user community type (310) from a drop down list of user community types and selects gossip as the category for his message (320) from a list of categories (e.g. Announcements, Clubs, Cafeteria, Tutoring, Buses) for the school user community type (310). The sender clicks the send button to send the message (330) to that user community name. At the bottom section of the web page is the list of posted messages for the school user community where the category icon representing the category of each message is displayed next to each message (340). Message recipients can search for posted messages using a filter (350). The display of icons next to each message enables viewers to visually identify categories of multiple messages without having to access each category separately and without having to read each message separately. The category icons can be colored instead of black and white icons used for this example and can even be animated icons where multiple images can rotate within one image.

### CONCLUSION

Systems and methods described and consistent with the present invention permit a electronic message senders to add icons corresponding to categories of user community types. The category icons are displayed next to electronic messages when viewed by one or more message recipients so that the category of a message is visually identified enabling users to easily find the preferred category and to quickly explore multiple categories in parallel without performing extra steps when accessing multiple categories. Category icons can be made as viewable and recognizable as possible for viewers and can also be animated if the display medium allows it.

What is claimed is:

1. A computer implemented method for adding a category icon to an electronic message, the electronic message being created by a sender for one or more recipients of a user community having a plurality of categories, comprising: providing the sender with a list of user community types when creating the electronic message; receiving from the sender the selection of a user community type from the list of user community types; providing the sender with a list of categories for the selected user community type and a category icon associated with each category; receiving from the sender the selection of a category from the list of categories; and appending the category icon corresponding to the selected category to the electronic message, wherein the category icon is subsequently displayed with the electronic message to one or more recipients of a user community to provide visual identification of the category of each electronic message.

2. The method of claim 1, wherein the category icon associated with each category is one of: a static image, an animated image, and a symbol that is different for each category.

3. The method of claim 1, wherein the electronic message is one of: a chat session message, an email, a short instant message and a forum post.

4. The method of claim 1, wherein the user community type is one of: an educational institute, a group of professionals, an organization, a company, a country, a city, a neighborhood within a city, a family, a group of friends, a web forum, and a social media web site.

5. The method of claim 1, wherein displaying the category icon with the electronic message is based on the type of display medium having graphics capability when the category icon is an image.

6. The method of claim 1, wherein the method is implemented with an executable computer program stored on an electronic storage medium and having communication capability over a network to perform the steps of claim 1.

7. A system for adding a category icon to an electronic message, the electronic message being created by a sender for one or more recipients of a user community having a plurality of categories, comprising: at least one non-transitory computer readable medium; at least one processor; at least one network accessible database where user community types, categories of user community types and category icons associated with categories are stored; and instructions on the at least one non-transitory computer readable medium which are configured to perform the following steps: providing the sender with a list of user community types when creating the electronic message; receiving from the sender the selection of a user community type from the list of user community types; providing the sender with a list of categories for the selected user community type and a category icon associated with each category; receiving from the sender the selection of a category from the list of categories; and appending the category icon corresponding to the selected category to the electronic message, wherein the category icon is subsequently displayed with the electronic message to one or more recipients of a user community to provide visual identification of the category of each electronic message.
